(19) United States
(12) Patent Application Publication
(10) Pub. No.: US 2025/0286481 A1
(43) Pub. Date: Sep. 11, 2025

(54) POWER TOOL INCLUDING SECONDARY ENERGY STORAGE

(71) Applicant: MILWAUKEE ELECTRIC TOOL CORPORATION, Brookfield, WI (US)

(72) Inventors: Kerry J. Woodbury, Port Washington, WI (US); Douglas R. Fieldbinder, Greendale, WI (US)

(21) Appl. No.: 19/069,875

(22) Filed: Mar. 4, 2025

Related U.S. Application Data
(60) Provisional application No. 63/562,571, filed on Mar. 7, 2024.

(51) Int. Cl. H02P 3/14; B25F 5/00

(52) U.S. Cl. CPC H02P 3/14; B25F 5/00

(57) ABSTRACT

Examples provide a power tool including a power input interface electrically connectable to a power source; a motor; a DC-DC power converter electrically connected to the motor; a secondary energy storage device electrically connected to the DC-DC power converter; and a controller electrically connected to the DC-DC power converter, the controller configured to control the DC-DC power converter to route a braking current generated by the motor to the secondary energy storage device during a regenerative braking operation.

### FIELD

Examples described herein relate to power tools.

### SUMMARY

Power tools described herein include a power input interface electrically connectable to a power source; a motor; a DC-DC power converter electrically connected to the motor; a secondary energy storage device electrically connected to the DC-DC power converter; and a controller electrically connected to the DC-DC power converter, the controller configured to control the DC-DC power converter to route a braking current generated by the motor to the secondary energy storage device during a regenerative braking operation.

In some aspects, the DC-DC power converter is configured to regulate power provided to the secondary energy storage device from the motor during the regenerative braking operation.

In some aspects, the DC-DC power converter is a bidirectional DC-DC power converter configured to regulate power discharged from the secondary energy storage device.

In some aspects, the power tool further includes a power switching network electrically connected to the motor and the DC-DC power converter, wherein the controller is configured to control the power switching network to perform the regenerative braking operation.

In some aspects, the controller is further configured to selectively provide energy stored in the secondary energy storage device to one of the motor or to the power source.

In some aspects, the controller is configured to selectively provide the energy stored in the secondary energy storage device to the motor as a motor plugging current during a braking operation of the motor.

In some aspects, the controller is configured to selectively provide the energy stored in the secondary energy storage device to the motor as supplementary power for driving the motor.

In some aspects, the controller is configured to provide power from the power source and the supplementary power from the secondary energy storage device to the motor at startup.

In some aspects, the controller is configured to provide the supplementary power in response to determination that a voltage of the power source is below a threshold during a driving operation of the motor.

In some aspects, the controller is configured to provide the supplementary power in response to determination that a power demand of the motor is greater than a threshold.

In some aspects, the power tool further includes a user input interface; wherein the controller is further configured to receive user input via the user input interface indicating that a boost operation is requested, and selectively provide the energy stored in the secondary energy storage device to the motor as supplementary power for driving the motor in response to determining that the boost operation is requested.

In some aspects, the controller is configured to selectively provide the energy stored in the secondary energy storage device to the power source in response to determining that the motor is in an idle state.

In some aspects, the secondary energy storage device includes at least one selected from the group consisting of a capacitor, a supercapacitor, a battery cell, and a power tool battery pack.

In some aspects, the power source is a removable battery pack.

Power tools described herein include: a battery pack interface electrically connectable to a battery pack; a motor; a DC-DC power converter electrically connected to the motor; a secondary energy storage device electrically connected to the DC-DC power converter; and a controller electrically connected to the DC-DC power converter, the controller configured to control DC-DC power converter to route a braking current generated by the motor to the secondary energy storage device during a regenerative braking operation.

In some aspects, the controller is further configured to responsive to determining that a first operating condition of the power tool is met, selectively provide energy stored in the secondary energy storage device to the motor, responsive to determining that the first operating condition of the power tool is not met and that a second operating condition of the power tool is met, selectively provide the energy stored in the secondary energy storage device to the power tool battery pack, and responsive to determining that the first operating condition and the second operating condition are not met, selectively enable the energy stored in the energy storage device to dissipate.

Methods for operating a power tool including a power input interface electrically connectable to a power source, a motor, a DC-DC power converter, and a secondary energy storage device described herein include: controlling the DC-DC power converter to route a braking current generated by the motor to the secondary energy storage device during a regenerative braking operation.

In some aspects, the method further includes selectively providing energy stored in the secondary energy storage device to one selected form a group consisting of the motor and the power source.

In some aspects, the energy stored in the secondary energy storage device to the motor is selectively provided to the motor as a motor plugging current during a braking operation of the motor.

In some aspects, the energy stored in the secondary energy storage device to the motor is selectively provided to the motor as supplementary power for driving the motor.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a power tool, according to some examples.

FIG. 2 schematically illustrates a power tool, according to some examples.

FIG. 3 schematically illustrates an energy management system for a power tool, according to some examples.

FIG. 4 illustrates a method for controlling a power tool, according to some examples.

### DETAILED DESCRIPTION

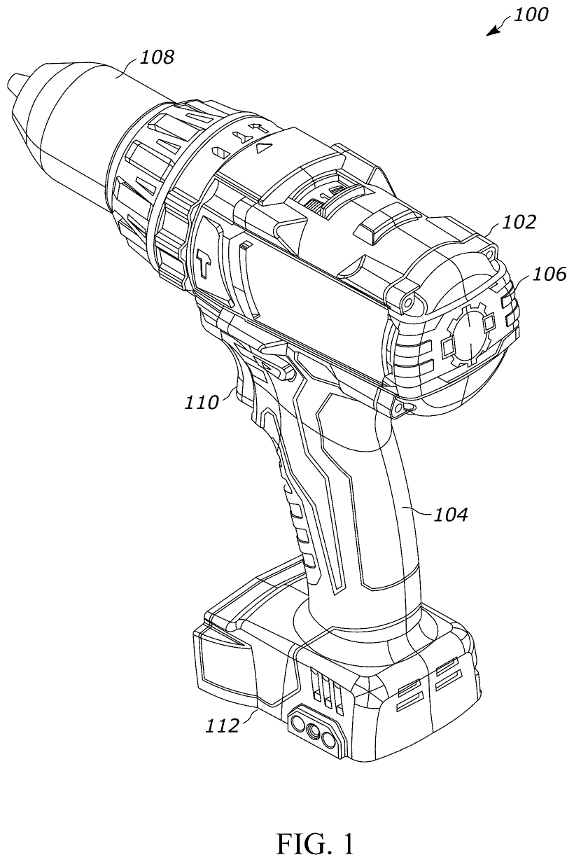

FIG. 1 illustrates a power tool 100 including a brushless direct current (“BLDC”) motor. The power tool 100 is, for example, a brushless hammer drill including a housing 102. The housing 102 includes a handle portion 104 and motor housing portion 106. The power tool 100 further includes an output driver 108 (illustrated as a chuck), a trigger 110, and a power input interface 112. The power input interface 112 is configured to mechanically and electrically connect to a power source for powering the tool 100. Although FIG. 1 illustrates a hammer drill, in some embodiments, the components and control techniques described herein are incorporated into other types of power tools including, for example, a circular saw, a jigsaw, a reciprocating saw, a bandsaw, a grinder, a cutoff saw, a tire buffer, a mud mixer, a bandfile, a polisher, a sander, a cutoff tool, a rotary hammer, a drill-driver, a hammer drill, a right angle drill, an impact driver, an impact wrench, a ratchet, a screwdriver, a crimper, a pipe threader, a pump, a cable cutter, a cable stripper, a rod cutter, a tube cutter, a pipe shear, a knockout tool, a PEX expander, an inflator, a compressor, a sewer drum, a transfer pump, a drain snake, a rivet tool, a heat gun, a grease gun, a caulk gun, a chain hoist, a track saw, a miter saw, a table saw, a multi-tool, a router, a planer, a vacuum, a fan, a blower, etc.

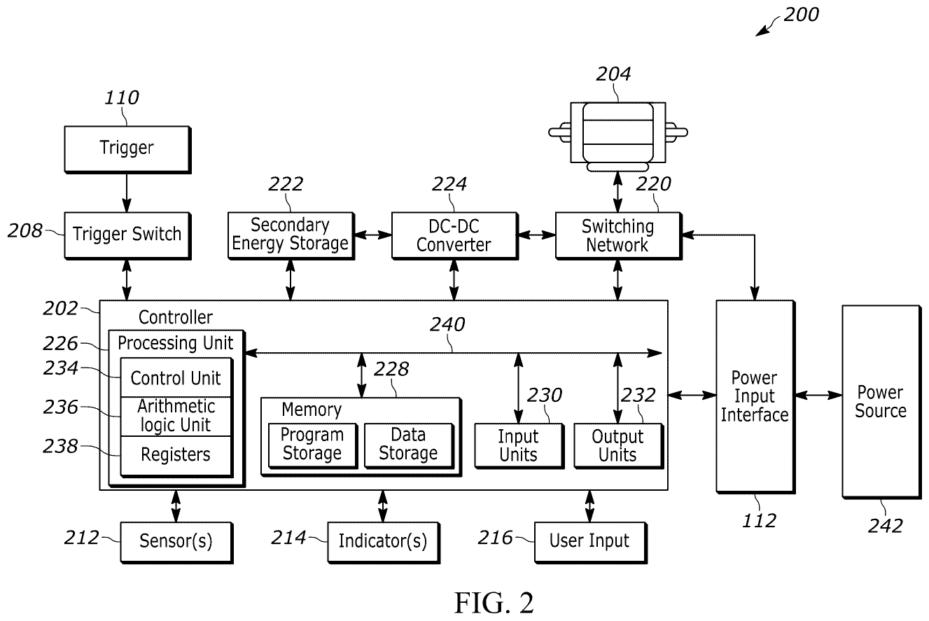

FIG. 2 illustrates a control system 200 for the power tool 100 that includes a secondary energy storage system. The control system 200 includes a controller 202. The controller 202 is electrically and/or communicatively connected to a variety of modules or components of the power tool 100. For example, the illustrated controller 202 is electrically connected to a motor 204, the power input interface 112, a trigger switch 208 (connected to the trigger 110), one or more sensors 212 (also referred to as sensing circuits), one or more indicators 214, a user input module 216, a power switching network 220, a secondary energy storage device 222, and a DC-DC converter 224. The controller 202 includes combinations of hardware and software that are operable to, among other things, control the operation of the power tool 100, monitor the operation of the power tool 100, activate the one or more indicators 214 (e.g., an LED), etc.

The power input interface 112 is electrically connectable to a power source 242. The power source 242 may be, for example, a rechargeable and removable power tool battery pack. While described herein as a battery pack 242, in some examples, the power source 242 is, for example, a portable power supply having a corded connection to the power input interface 112, an adapter for converting alternating current to direct current supplied to the power input interface, a power cord providing alternating current power input, or another type of power source. The power input interface 112 includes a combination of mechanical components (e.g., rails, grooves, latches, etc.) and electrical components (e.g., one or more terminals) configured to and operable for interfacing (e.g., mechanically, electrically, and communicatively connecting) with the battery pack 242. The power input interface 112 supplies power to the power switching network 220 to be switched by the switching FETs to selectively provide power to the motor 204.

The controller 202 includes a plurality of electrical and electronic components that provide power, operational control, and protection to the components and modules within the controller 202 and/or the power tool 100. For example, the controller 202 includes, among other things, a processing unit 226 (e.g., a microprocessor, a microcontroller, an electronic controller, an electronic processor, or another suitable programmable device and may be commonly referred to as an electronic processor), a memory 228, input units 230, and output units 232. The processing unit 226 includes, among other things, a control unit 234, an arithmetic logic unit (“ALU”) 236, and a plurality of registers 238, and is implemented using a known computer architecture (e.g., a modified Harvard architecture, a von Neumann architecture, etc.). The processing unit 226, the memory 228, the input units 230, and the output units 232, as well as the various modules or circuits connected to the controller 202 are connected by one or more control and/or data buses (e.g., common bus 240). The control and/or data buses are shown generally in FIG. 2 for illustrative purposes. The use of one or more control and/or data buses for the interconnection between and communication among the various modules, circuits, and components would be known to a person skilled in the art in view of the invention described herein.

The memory 228 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 226 is connected to the memory 228 and executes software instructions that are capable of being stored in a RAM of the memory 228 (e.g., during execution), a ROM of the memory 228 (e.g., on a generally permanent basis), or another non-transitory computer readable medium such as another memory or a disc. Software included in the implementation of the power tool 100 can be stored in the memory 228 of the controller 202. The software includes, for example, firmware, one or more applications, program data, filters, rules, one or more program modules, and other executable instructions. The controller 202 is configured to retrieve from the memory 228 and execute, among other things, instructions related to the control processes and methods described herein. In other constructions, the controller 202 includes additional, fewer, or different components.

In the example illustrated, the motor 204 is a three-phase brushless motor. In some example, the motor 204 may have more of fewer number of phases. The power switching network 220 includes, for example, an inverter having a plurality of switching FETs for driving the motor 204. In one example, the power switching network 220 is formed as an inverter bridge including three high-side switching FETs connected between a positive terminal of a power supply and motor terminals and three low-side switching FETs connected between the motor terminals and a negative terminal of the power supply or ground. In other examples, the motor 204 is a DC motor or a brushed motor and the power switching network 220 is modified accordingly. In some embodiments, the sensors 212 measure or detect a current in the power switching network 220 (e.g., a current of one or more phases of the inverter).

The trigger switch 208 provides information relating to the trigger 110 to the controller 202. In some examples, the trigger 110 is an ON/OFF power switch. In these examples, the trigger switch 208 may be connected between the power input interface 112 and power switching network 220 and may include a relay that is closed when the trigger 110 is turned ON and opened with the trigger 110 is turned OFF. In other examples, the trigger 110 may include a variable speed trigger. In these examples, the trigger switch 208 may include a wiper in addition to or in place of a relay. As the variable speed trigger is depressed, contacts of the variable speed trigger move along the wiper of the trigger switch 208 thereby providing the desired speed information to the controller 202.

The sensors 212 include one or more current sensors, one or more speed sensors, one or more Hall Effect sensors, one or more temperature sensors, etc. The indicators 214 include, for example, one or more light-emitting diodes (“LEDs”). The indicators 214 can be configured to display conditions of, or information associated with, the power tool 100. For example, the indicators 214 are configured to indicate measured electrical characteristics of the power tool 100, the status of the power tool, the status of the secondary energy storage device 222, etc. The user input module 216 is operably coupled to the controller 202 to, for example, select a forward mode of operation or a reverse mode of operation, a torque and/or speed setting for the power tool 100 (e.g., using torque and/or speed switches), etc. In some embodiments, the user input module 216 includes a combination of digital and analog input or output devices required to achieve a desired level of operation for the power tool 100, such as one or more knobs, one or more dials, one or more switches, one or more buttons, etc.

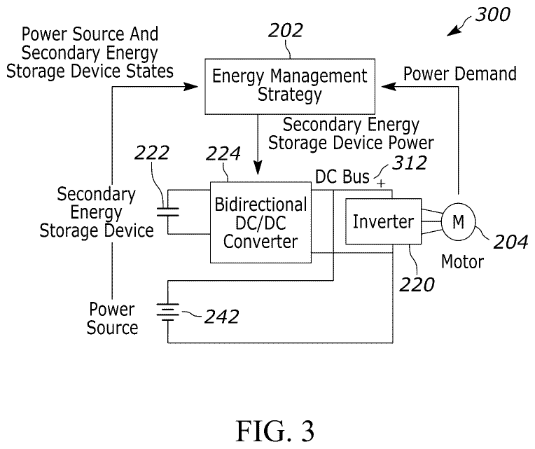

Referring to FIGS. 2 and 3, the secondary energy storage device 222 may include, for example, a capacitor, a supercapacitor, a battery pack (e.g., a secondary battery pack in addition to the battery pack 242), and/or the like. In some examples, the controller 202 may be directly connected to the secondary energy storage device 222. In other examples, the controller 202 may determine a state of the energy storage device using the sensors 212. A DC-DC power converter 224 is electrically connected to the secondary energy storage device 222, the power switching network 220, and the controller 202. In some examples, the DC-DC power converter 224 is connected between the power switching network 220 (e.g., an inverter) and the secondary energy storage device 222. In other examples, DC-DC power converter 224 may be connected directly to the motor 204 or connected to the motor via another intermediary power converter (e.g., a rectifier). In some examples, the DC-DC power converter 224 may also be connected to the power source 242 through the power input interface 112. Although FIG. 3 illustrates the main power source 242 as a battery and the secondary energy storage device 222 as a super-capacitor, the power source 242 and/or the secondary energy storage device 222 may take other forms as described above.

FIG. 3 illustrates an energy management system of the power tool 100. The power switching network 220 is connected between a DC bus 312 and the motor 204. The power switching network 220 may include a bidirectional circuit that selectively provides power from the DC bus 312 to the motor 204 (e.g., when driving the motor) and from the motor 204 to the DC bus 312 (e.g., when braking the motor). The DC bus 312 is also connected to the power source 242, the secondary energy storage device 222, and the DC-DC power converter 224. The DC-DC power converter 224 may be a bidirectional DC-DC power converter 224 that provides DC power from the secondary energy storage device 222 to the DC bus 312 and the DC bus 312 to the secondary energy storage device 222.

The controller 202 is configured to monitor the states of the power source 242, the secondary energy storage device 222, and the motor. For example, the controller 202 may monitor the voltage level (e.g., state of charge), the power draw, the temperature, error states, and the like of the power source 242 and the secondary energy storage device 222. The controller 202 may also monitor the power demand (e.g., the load) on the motor, for example, using load sensor, vibration sensors, and the like. The controller 202 provides control signals to the DC-DC power converter 224 to control the power flow between the DC bus 312 and the secondary energy storage device 222.

In some example, switches (e.g., FETs) may be arranged on the current path between the DC bus 312 and each of power source 242, the power switching network 220, and the DC-DC power converter 224 respectively. The switches selectively connect and disconnect the power source 242, the power switching network 220, and the DC-DC converter to the DC bus 312.

In some examples, the DC-DC power converter 224 is a bidirectional power converter configured to regulate power (e.g., boost or buck voltage) provided to and discharged from the secondary energy storage device 222 automatically or based on control signals received from the controller 202. For example, the DC-DC power converter 224 may regulate power discharged from the secondary energy storage device 222 that is provided to the motor 204 (e.g., via the power switching network 220) and/or the power source 242 (e.g., via the power input interface 112).

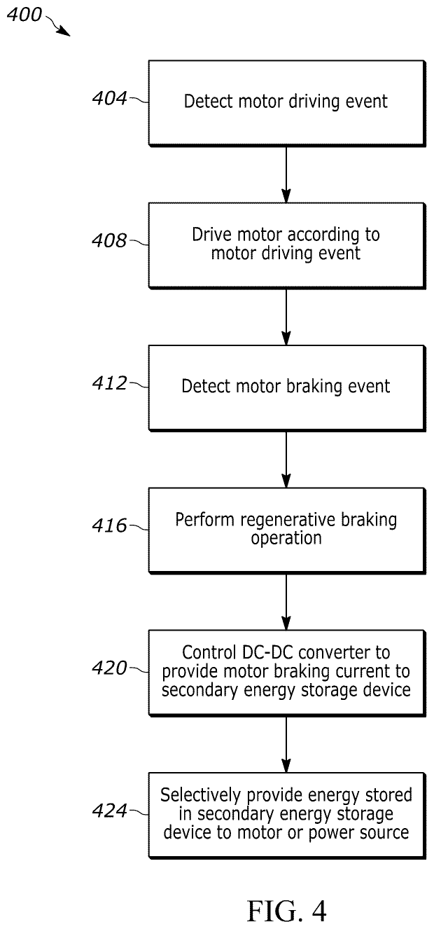

FIG. 4 illustrates a method 400 for energy management of the power tool 100. The method 400 may be performed by, for example, the controller 202 of the power tool 100. The method 400 includes detecting, using the controller 202, a motor driving event (at block 404). The motor driving event may include, for example, actuation of a power switch, a variable speed trigger (e.g., the trigger 110), actuation of a power switch and a speed dial, and/or the like. The controller 202 may detect the motor driving event based on signals from the trigger switch 208 or the sensors 212.

The method 400 includes, in response to detecting the motor driving event, driving, using the power switching network 220, the motor 204 according to the motor driving event (e.g., according to a speed and/or torque associated with the motor driving event) (at block 408). During operation of the power tool 100, the controller 202 is configured to control the power switching network 220 to drive the motor 204 in response to, for example, detecting actuation of the trigger 110. As described above, the power switching network 220 may be formed as an inverter electrically connected between the DC bus 312 and the motor 204. The controller 202 may provide pulse width modulated (PWM) signals to the FETs of the power switching network 220 to drive the motor 204 according to the motor driving event. Driving the motor 204 causes a motor driving current to flow from, for example, the DC bus 312 to the motor 204 via the power switching network 220.

The method 400 also includes detecting, using the controller 202, a motor braking event (at block 412). The motor braking event may include, for example, a release of the trigger 110, actuation of a power switch into an OFF state, a speed reduction according to a speed dial of the tool 100, a kickback event of the tool 100, actuation of an emergency stop input included in the user input module 216, a torque limit of the motor 204 being reached, and/or the like. The controller 202 may detect the motor driving event based on signals from the trigger switch 208 or the sensors 212.

The method 400 includes braking, using the controller 202, the motor in response to the motor braking event (at block 416). The controller 202 may brake the motor by disconnecting the power source 242 from the DC bus 312. The method 400 further includes controlling the DC-DC power converter 224 to provide a current generated by the motor 204 to the secondary energy storage device 222, the current being generated during motor braking (at block 420). The controller 202 may control the power switching network 220 to perform a regenerative braking operation of the motor 204 that causes a braking current generated by the motor 204 to be redirected to the secondary energy storage device 222 through the DC-DC power converter. For example, the controller 202 may control a switch arranged between the power source 242 and the power switching network 220 to open such that braking current generated by the motor 204 is routed to the secondary energy storage device 222 via the DC-DC power converter 224. During the regenerative braking operation, the DC-DC power converter 224 may convert the regenerative braking current received via the power switching network 220 to an appropriate voltage for charging the secondary energy storage device 222. In some examples, the power switching network 220 may be bypassed (e.g., using a bypass switching arrangement) such that the DC-DC power converter 224 is connected to the motor 204 (that is, motor coils) directly or through a rectifier.

The method 400 further includes selectively providing, using the controller 202 energy stored in the secondary energy storage device 222 to one of the motor 204 or the power source 242 (at block 424). Based on state information received from the secondary energy storage device 222, the battery pack 242, the motor 204, and/or other components of the tool 100, the controller 202 may provide the stored energy in the secondary energy storage device 222 to one of the motor 204 or the power source 242. For example, the controller 202 may determine a charge state (e.g., a voltage level) of the battery pack 242, a charge state of the secondary energy storage device 222, a power demand of the motor 204, a user input of the tool 100, and/or one or more operations executed by the motor (e.g., a motor braking operation, a motor driving operation, etc.), and output a control signal to the power switching network 220 to control whether and how power is discharged from the secondary energy storage device 222.

In some examples, the controller 202 selectively provides (e.g., by controlling the power switching network 220) energy stored in the secondary energy storage device 222 to the motor 204 as a motor plugging current in order to brake the motor 204 more quickly during a braking operation (e.g., in response to detecting a motor braking event).

In some examples, the controller 202 selectively provides the energy stored in the secondary energy storage device 222 to the motor 204 as supplementary power for driving the motor 204. The supplementary power is provided to the motor 204 in addition to the power provided by the power source 242 during the driving operation of the motor 204. For example, in some examples, the controller 202 controls the power switching network 220 to provide power from the power source 242 and the supplementary power from the secondary energy storage device 222 at startup of the motor 204.

In some examples, the controller 202 provides the supplementary power from the secondary energy storage device 222 in response to determining that the voltage of the power source 242 is below a threshold voltage for driving the motor 204 and/or otherwise powering the tool 100. In such examples, the controller 202 may provide the supplementary power from the secondary energy storage device 222 as a portion of or all of the total power provided to the motor 204. For example, the controller 202 may control the power switching network 220 to discharge the secondary energy storage device 222 according to a difference between a power requirement of the tool and an amount of power that can be provided by the power source 242 (e.g., based on a determined voltage state of the power source 242).

In some examples, the controller 202 provides the supplementary power from the secondary energy storage device 222 based on a power demand from the motor 204. For example, in response to determining that a power demand of the motor 204 is greater than a threshold (for example, during different types of driving operations or modes of the tool 100), the controller 202 may control the power switching network 220 such that power is provided from both the power source 242 and the secondary energy storage device 222 to drive the motor 204.

In some examples, the user input module 216 of the tool 100 includes a boost operation input (e.g., a push button, a switch, and/or the like) for triggering a boost mode of the tool 100 (e.g., for driving the motor 204 at a higher power). Responsive to receiving user input via the user input module 216 indicating that a boost operation is requested, the controller 202 controls the power switching network 220 to selectively provide energy stored in the secondary energy storage device 222 as supplementary power for driving the motor 204 during a boost operation. The controller 202 may drive the motor 204 in the boost operation until the controller 202 receives user input deactivating the boost mode, until the energy stored in the energy storage device is 222 is depleted, until a predetermined period of time for performing the boost operation has elapsed, and/or the like.

In some examples, the controller 202 selectively provides the energy stored in the secondary energy storage device 222 to the power source 242 in response to determining that the motor 204 is in an idle state (e.g., during power down of the tool 100 and/or when the motor 204 is otherwise not being driven) and that a charge state of the power source 242 is below a threshold. For example, in response to determining that the power source 242 is not fully charged, the controller 202 controls the DC-DC power converter 224 to charge the power source 242 using energy stored in the secondary energy storage device 222 by, for example, converting power stored in the secondary energy storage device 222 to a higher voltage level than that of the power source 242 such that a charging current flows form the secondary energy storage device 222 to the power source 242.

In some examples, controller 202 controls the DC-DC power converter 224 to regulate power discharged from the secondary energy storage device 222 such that the energy stored in the secondary energy storage device 222 gradually dissipates over time. For example, in response to determining that the motor 204 is in an idle state and that the charge state of the power source 242 is greater than a threshold (e.g., fully charged), the controller 202 controls the power switching network 220 to enable the energy stored in the secondary energy storage device 222 to dissipate. In some examples, the controller 202 enables the energy stored in the secondary energy storage device 222 to dissipate in response to determining that the power source 242 is not connected to the tool 100.

In some examples, responsive to determining that a first operating condition is met, the controller 202 may selectively provide energy stored in the secondary energy storage device 222 to the motor 204 (e.g., as supplementary current or as motor plugging current). The first operating condition may include, for example, a braking operation of the tool 100, an increased power demand of the motor 204, a startup operation of the motor 204, a low voltage condition of the power source 242 during driving of the motor 204, a requested boost operation of the tool 100, and/or the like.

Responsive to determining that a second operating condition is met (or the second operating condition is met and first operating condition is not met), the controller 202 may selectively provide energy stored in the secondary energy storage device 222 to the power source 242. The second operating condition may include, for example, a low voltage condition of the power source 242 (e.g., during an idle state of the motor 204).

In some examples, responsive to determining that neither the first nor second operating conditions are met, the controller 202 may enable the energy stored in the secondary energy storage device 222 to dissipate.

The method 400 illustrates only example embodiments. The blocks described with respect to this method need not all be performed or performed in the same order as described to carry out the method. One of ordinary skill in the art appreciates that the method 400 may be performed with the blocks in any order or by omitting certain blocks altogether.

Thus, embodiments described herein provide a power tool including a secondary energy storage device. Various features and advantages of the embodiments are set forth in the following aspects:

What is claimed is:

1. A power tool comprising:
a power input interface electrically connectable to a power source;
a motor;
a DC-DC power converter electrically connected to the motor;
a secondary energy storage device electrically connected to the DC-DC power converter; and
a controller electrically connected to the DC-DC power converter, the controller configured to control the DC-DC power converter to provide a current generated by the motor to the secondary energy storage device, the current being generated during motor braking.

2. The power tool of claim 1, wherein the DC-DC power converter is configured to regulate power provided to the secondary energy storage device from the motor during motor braking.

3. The power tool of claim 1, wherein the DC-DC power converter is a bidirectional DC-DC power converter configured to regulate power discharged from the secondary energy storage device.

4. The power tool of claim 1, further comprising:
a power switching network electrically connected to the motor and the DC-DC power converter, wherein the controller is configured to control the power switching network to perform motor braking.

5. The power tool of claim 4, wherein the controller is further configured to selectively provide energy stored in the secondary energy storage device to one selected from a group consisting of the motor and the power source.

6. The power tool of claim 5, wherein the controller is configured to selectively provide the energy stored in the secondary energy storage device to the motor as a motor plugging current during a braking operation of the motor.

7. The power tool of claim 5, wherein the controller is configured to selectively provide the energy stored in the secondary energy storage device to the motor as supplementary power for driving the motor.

8. The power tool of claim 7, wherein the controller is configured to provide power from the power source and the supplementary power from the secondary energy storage device to the motor at startup.

9. The power tool of claim 7, wherein the controller is configured to provide the supplementary power in response to determination that a voltage of the power source is below a threshold during a driving operation of the motor.

10. The power tool of claim 7, wherein the controller is configured to provide the supplementary power in response to determination that a power demand of the motor is greater than a threshold.

11. The power tool of claim 7, further comprising:
a user input interface;
wherein the controller is further configured to
receive user input via the user input interface indicating that a boost operation is requested, and
selectively provide the energy stored in the secondary energy storage device to the motor as supplementary power for driving the motor in response to determining that the boost operation is requested.

12. The power tool of claim 1, wherein the controller is configured to selectively provide energy stored in the secondary energy storage device to the power source in response to determining that the motor is in an idle state.

13. The power tool of claim 1, wherein the secondary energy storage device includes at least one selected from the group consisting of a capacitor, a supercapacitor, a battery cell, and a power tool battery pack.

14. The power tool of claim 1, wherein the power source is a removable battery pack.

15. A power tool comprising:
a battery pack interface electrically connectable to a battery pack;
a motor;
a DC-DC power converter electrically connected to the motor;
a secondary energy storage device electrically connected to the DC-DC power converter; and
a controller electrically connected to the DC-DC power converter, the controller configured to control DC-DC power converter to provide a braking current generated by the motor to the secondary energy storage device during motor braking.

16. The power tool of claim 15, wherein the controller is further configured to
responsive to determining that a first operating condition of the power tool is met, selectively provide energy stored in the secondary energy storage device to the motor,
responsive to determining that the first operating condition of the power tool is not met and that a second operating condition of the power tool is met, selectively provide the energy stored in the secondary energy storage device to the battery pack, and
responsive to determining that the first operating condition and the second operating condition are not met, selectively enable the energy stored in the secondary energy storage device to dissipate.

17. A method for operating a power tool including a power input interface electrically connectable to a power source, a motor, a DC-DC power converter, and a secondary energy storage device, the method comprising:
controlling the DC-DC power converter to provide a braking current generated by the motor to the secondary energy storage device during motor braking.

18. The method of claim 17, further comprising:
selectively providing energy stored in the secondary energy storage device to one selected form a group consisting of the motor and the power source.

19. The method of claim 18, wherein the energy stored in the secondary energy storage device to the motor is selectively provided to the motor as a motor plugging current during a braking operation of the motor.

20. The method of claim 18, wherein the energy stored in the secondary energy storage device to the motor is selectively provided to the motor as supplementary power for driving the motor.
